(19) United States
(12) Patent Application Publication
(10) Pub. No.: US 2018/0166966 A1
(43) Pub. Date: Jun. 14, 2018

(54) IMPROVEMENTS IN OR RELATING TO THE CONTROL OF VOLTAGE SOURCE CONVERTERS

(71) Applicant: General Electric Technology GmbH, Baden (CH)

(72) Inventors: Pablo BRIFF, Stafford (GB); Omar Fadhel JASIM, Nottingham (GB); Francisco Jose MORENO MUNOZ, Bera (Navarra) (ES)

(21) Appl. No.: 15/577,700

(22) PCT Filed: May 25, 2016
(86) PCT No.: PCT/EP2016/061857

§ 371 Date: Nov. 28, 2017

(30) Foreign Application Priority Data
May 28, 2015 (GB) 1509189.5

(51) Int. Cl. H02M 1/00; H02M 7/217

(52) U.S. Cl. CPC H02M 1/00; H02M 2001/0009; H02M 2001/0048; H02M 7/217

(57) ABSTRACT

A method of controlling a voltage source converter including a converter limb corresponding to a respective phase of the converter, each converter limb extending between first and second DC terminals and including first and second limb portions separated by an AC terminal and each limb portion including a chain-link converter which is operable to provide a stepped variable voltage source, includes the steps of obtaining a AC current demand phase waveform and a DC current demand for each corresponding converter limb is configured to track, and carrying out mathematical optimization to determine an optimal limb portion current for each limb portion must contribute to track the corresponding required AC current demand phase waveform and the required DC current demand while minimising current conduction losses within each limb portion and additionally managing the energy stored by each chain-link converter.

### BACKGROUND OF THE INVENTION

Embodiments of the invention relate to a method of controlling a voltage source converter and to such a voltage source converter.

In high voltage direct current (HVDC) power transmission networks alternating current (AC) power is typically converted to direct current (DC) power for transmission via overhead lines and/or under-sea cables. This conversion removes the need to compensate for the AC capacitive load effects imposed by the power transmission medium, i.e. the transmission line or cable, and reduces the cost per kilometre of the lines and/or cables, and thus becomes cost-effective when power needs to be transmitted over a long distance.

The conversion between DC power and AC power is utilized in power transmission networks where it is necessary to interconnect the DC and AC electrical networks. In any such power transmission network, converters are required at each interface between AC and DC power to effect the required conversion; AC to DC or DC to AC.

A particular type of converter is a voltage source converter which is operable to generate an AC voltage waveform at one or more AC terminals thereof in order to provide the aforementioned power transfer functionality between the AC and DC electrical networks.

### BRIEF DESCRIPTION OF THE INVENTION

According to a first aspect of embodiments of the invention there is provided a method of controlling a voltage source converter including at least one converter limb corresponding to a respective phase of the converter, the or each converter limb extending between first and second DC terminals and including first and second limb portions separated by an AC terminal, each of which limb portion includes a chain-link converter operable to provide a stepped variable voltage source, the method comprising the steps of:

(a) obtaining a respective AC current demand phase waveform for the or each converter limb which the corresponding converter limb is required to track, and a DC current demand which the or each converter limb is also required to track; and
(b) carrying out mathematical optimization to determine an optimal limb portion current for each limb portion that the limb portion must contribute to track the corresponding required AC current demand phase waveform and the required DC current demand while minimising current conduction losses within each limb portion and additionally managing the energy stored by each chain-link converter.

Carrying out mathematical optimization to determine optimal limb portion currents which track the corresponding required AC current demand phase waveform and the required DC current while minimising current conduction losses within each limb portion allows both the AC and DC power demands of a particular voltage source converter installation to be met, e.g. according to the voltage source converter owner's operational requirements, in a manner that reduces operational losses and so improves the efficiency and cost-effectiveness of the said particular voltage source converter installation.

In the meantime, carrying out mathematical optimization to determine optimal limb portion currents which track the corresponding required AC current demand phase waveform and the required DC current while additionally managing the energy stored by each chain-link converter, avoids the need for separate control loops to deal with such stored energy management. The avoidance of such separate control loops is highly desirable because they otherwise adversely impact on the optimal limb portion currents determined to minimise current conduction losses, thereby degrading the associated efficiency improvements. In addition, separate control loops cause individual chain-link converters to compete with one another from a stored energy management perspective and thereby prevent the chain-link converters from achieving, e.g. near-zero energy deviation from a desired target stored energy.

In an embodiment, managing the energy stored by each chain-link converter includes balancing the energy stored by each chain-link converter.

Balancing the energy stored by each chain-link converter is advantageous because it helps to ensure that the energy stored by components within each chain-link converter, e.g. respective chain-link modules having an energy storage device in the form of a capacitor, is similarly evenly balanced, i.e. the capacitors have roughly the same amount of charge as one another during operation of the associated voltage source converter. Such energy balancing of, e.g. chain-link modules, is highly beneficial as it helps to maintain correct functioning of the voltage source converter, thus maximising its lifetime, robustness, performance and stability.

In an embodiment of the invention, further comprising within step (a) obtaining a target stored energy that each chain-link converter should aim to have stored therein under steady-state operating conditions, managing the energy stored by each chain-link converter includes minimising the deviation in energy stored by each chain-link converter from the target stored energy it should have stored.

Minimising the deviation in energy stored by each chain-link converter from a target stored energy level is beneficial because it helps to lead to the balance of energy stored by each chain-link converter and the components therein, along with the associated benefits mentioned above. Moreover, having the energy stored by each chain-link converter conform to a desired target means that each limb portion within a given converter limb is operating in an optimal manner which helps to ensure that neither the overall performance nor endurance of the voltage source converter is degraded over time.

Optionally step (b) of carrying out mathematical optimization to determine an optimal limb portion current for each limb portion includes applying a first weighting to the extent to which current conduction losses are minimised and a second different weighting to the degree of stored energy management carried out.

Step (b) of carrying out mathematical optimization to determine an optimal limb portion current for each limb portion may include applying a second different weighting to the degree of stored energy balancing carried out and a third further different weighting to the extent to which stored energy deviation is minimised.

The foregoing steps allow the method of embodiments of the invention to tailor its functionality in order to accommodate different operating conditions, such as power ramping, steady-state power supply or a fault condition, while continuing to track the or each required AC current demand phase waveform and the required DC current demand, as well as minimise current conduction losses within each limb portion and additionally manage the energy stored by each chain-link converter.

In an embodiment, step (b) of carrying out mathematical optimization to determine an optimal limb portion current for each limb portion includes establishing a quadratic optimization problem of the general form

$${min}_{x} J = Ψ ( x ( {t}_{1} ) ) + {\int }_{{t}_{0}}^{{t}_{1}} f ( x ( t ) , t ) dt$$

where,

J is a current objective function to be minimized;

ψ is a current weighting at time t₁;

f is a current cost function;

t₀ is the time at which a particular period of control of a particular voltage source converter starts; and

t₁ is the time at which the particular period of control of a particular voltage source converter ends.

The current objective function to be minimized may take the form

J(I,Ē)

where,

I is an optimal limb portion currents vector composed of individual limb portion currents that each corresponding limb portion must contribute; and

Ē is an average chain-link converters stored energy vector composed of individual average energy amounts that each chain-link converter is actually storing.

Optionally the current objective function to be minimized is defined by a linear combination of current conduction losses, stored energy deviations between the chain-link converters, and stored energy deviations from a target stored energy.

In an embodiment of the invention the current conduction losses are given by

I^{T}·I

where,

I is an optimal limb portion currents vector composed of individual limb portion currents that each corresponding limb portion must contribute.

The stored energy deviations between the chain-link converters may be given by

$${\sum }_{{{\overline{E}}_{i} , {\overline{E}}_{j}}_{i \neq j}} {( {\overline{E}}_{i} - {\overline{E}}_{j} )}^{2}$$

where,

Ēᵢ is the average energy stored in an i-th chain-link converter; and

Ēⱼ is the average energy stored in a j-th chain-link converter.

Optionally the stored energy deviations from a target stored energy are given by

$${\sum }_{{\overline{E}}_{i} ,} {( {\overline{E}}_{i} - {E}_{{0}_{i}} )}^{2}$$

where,

Ēᵢ is the average energy stored in an i-th chain-link converter; and

E₀_{ᵢ} is the target stored energy an i-th chain-link converter should have stored under steady-state operating conditions.

The various foregoing features desirably permit the utilization of mathematical optimization in the control of a voltage source converter, and thereby provide for the associated advantages, in a manner that is readily tailored to the specific configuration of a given voltage source converter.

In another embodiment of the invention the current objective function is minimised subject to a first equality constraint expressed as a linear equation of the form

A₁·x=b₁

and firstly incorporating power demands based on the respective AC current demand phase waveform for the or each converter limb and the DC current demand, as well as secondly incorporating stored energy compensation factors.

Such a step desirably restrains the possible set of solutions that minimises the current objective function in a manner that desirably incorporates management of the energy stored by each chain-link converter.

In a further embodiment of the invention the current objective function is minimised subject to an additional second equality constraint expressed as a linear equation of the form

A₂·x=b₂

and incorporating a consideration of changes in the average energy stored by each chain-link converter.

It is advantageous to take into account the effect an instantaneous level of optimal limb portion current has on the average energy the corresponding chain-link converter stores since the current objective function modifies such instantaneous currents to manage the time-averaged energy stored by a particular chain-link converter.

In a method of controlling a voltage source converter including a plurality of converter limbs, the current objective function is minimised subject to an additional third equality constraint expressed as a linear equation of the form

A₃·x=b₃

and incorporating a requirement that the AC current demand phase waveform for each converter limb sums to zero at the corresponding AC terminal.

Such a step helps to eliminate the inclusion of AC components in the DC current demand routed between the first and second DC terminals, and so avoid the need to filter this current before, e.g. passing it to a DC network connected in use to the first and second DC terminals.

Any kind of filter in, e.g. a HVDC installation, has major implications with regards to the footprint of a resulting converter station, and so avoiding such filters is very beneficial.

In an embodiment, the first, second, and third equality constraints are concatenated into a compact linear system of the form

A·x=b

where,

A is defined as

$$A = [ \begin{matrix}{A}_{1} \\ {A}_{2} \\ {A}_{3}\end{matrix} ]$$

and b is defined as:

$$b = [ \begin{matrix}{b}_{1} \\ {b}_{2} \\ {b}_{3}\end{matrix} ]$$

Carrying out such concatenation leads to a single, computationally efficient equality constraint and so reduces the processing overhead associated with the method of embodiments of the invention.

In an embodiment of the invention the state vector is given by

x(k)=[I(k)Ē(k)]^{T}

where,

I is an optimal limb portion currents vector composed of individual limb portion currents that each corresponding limb portion must contribute; and

Ē is an average chain-link converters stored energy vector composed of individual average energy amounts that each chain-link converter is actually storing.

Defining the state vector, i.e x(k), in this manner beneficially unites the two unknowns, i.e. I(k)Ē(k) in a single equation that can then be readily constrained as required.

According to a second aspect of embodiments of the invention there is provided a voltage source converter comprising at least one converter limb corresponding to a respective phase of the converter, the or each converter limb extending between first and second DC terminals and including first and second limb portions separated by an AC terminal, each of which limb portion includes a chain-link converter operable to provide a stepped variable voltage source, the voltage source converter further comprising a controller programmed to:

(a) obtain a respective AC current demand phase waveform for the or each converter limb which the corresponding converter limb is required to track, and a DC current demand which the or each converter limb is also required to track; and
(b) carry out mathematical optimization to determine an optimal limb portion current for each limb portion that the limb portion must contribute to track the corresponding required AC current demand phase waveform and the required DC current demand while minimising current conduction losses within each limb portion and additionally managing the energy stored by each chain-link converter.

The voltage source converter of embodiments of the invention shares the benefits associated with the corresponding method steps of embodiments of the invention.

### BRIEF DESCRIPTION OF THE DRAWINGS

There now follows a brief description of embodiments of the invention, by way of non-limiting example, with reference being made to the following figures in which:

FIG. 1 shows a flow diagram which illustrates principle steps in a method of controlling a voltage source converter;

FIG. 2 shows a schematic representation of an example voltage source converter being controlled by the first method; and

FIG. 3 illustrates how the voltage source converter shown in FIG. 2 is controlled to manage the energy stored by respective chain-link converters within the voltage source converter.

### DETAILED DESCRIPTION

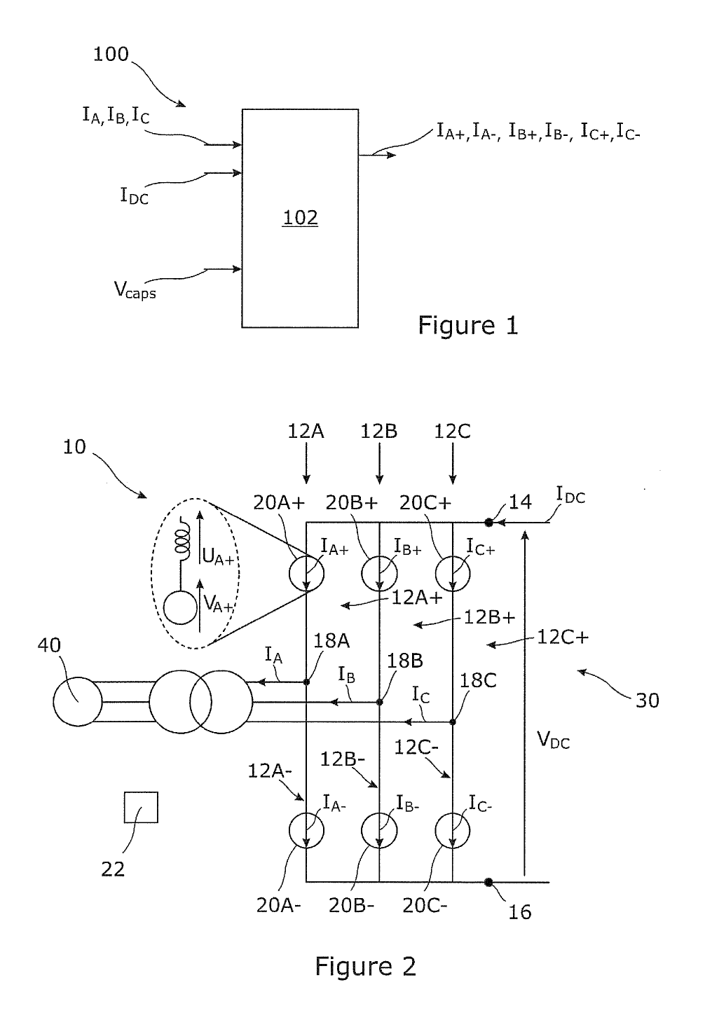

Principle steps in a method according to a first embodiment of the invention of controlling a voltage source converter are illustrated in a flow diagram 100 shown in FIG. 1.

The first method of embodiments of the invention is applicable to any voltage source converter topology, i.e. a converter including in each limb portion thereof a chain-link converter operable to provide a stepped variable voltage source, irrespective of the particular converter structure. By way of example, however, it is described in connection with a three-phase voltage source converter 10 which has three converter limbs 12A, 12B, 12C, each of which corresponds to one of the three phases A, B, C. In other embodiments of the invention the voltage source converter structure being controlled may have fewer than or more than three phases and hence a different commensurate number of corresponding converter limbs.

In the example three-phase voltage source converter 10 shown, each converter limb 12A, 12B, 12C extends between first and second DC terminals 14, 16 that are connected in use to a DC network 30, and each converter limb 12A, 12B, 12C includes a first limb portion 12A+, 12B+, 12C+ and a second limb portion 12A−, 12B−, 12C−. Each pair of first and second limb portions 12A+, 12A−, 12B+, 12B−, 12C+, 12C− in each converter limb 12A, 12B, 12C is separated by a corresponding AC terminal 18A, 18B, 18C which is connected in use to a respective phase A, B, C of an AC network 40.

Each limb portion 12A+, 12A−, 12B+, 12B−, 12C+, 12C− includes a chain-link converter 20A+, 20A−, 20B+, 20B−, 20C+, 20C− which is operable to provide a corresponding stepped variable voltage source VA+ (only one such variable voltage source being shown in FIG. 2).

Each chain-link converter 20A+, 20A−, 20B+, 20B−, 20C+, 20C− includes a plurality of series connected chain-link modules (not shown). Each chain-link module includes a number of switching elements which are connected in parallel with an energy storage device in the form of a capacitor. Each switching element includes a semiconductor device in the form of, e.g. an Insulated Gate Bipolar Transistor (IGBT), which is connected in parallel with an anti-parallel diode. It is, however, possible to use other semiconductor devices.

An example first chain-link module is one in which first and second pairs of switching elements and a capacitor are connected in a known full bridge arrangement to define a 4-quadrant bipolar module. Switching of the switching elements selectively directs current through the capacitor or causes current to bypass the capacitor such that the first module can provide zero, positive or negative voltage and can conduct current in two directions.

An example second chain-link module is one in which only a first pair of switching elements is connected in parallel with a capacitor in a known half-bridge arrangement to define a 2-quadrant unipolar module. In a similar manner to the first chain-link module, switching of the switching elements again selectively directs current through the capacitor or causes current to bypass the capacitor such that the second chain-link module can provide zero or positive voltage and can conduct current in two directions.

In either foregoing manner it is possible to build up a combined voltage across each chain-link converter 20A+, 20A−, 20B+, 20B−, 20C+, 20C− by combining the individual voltage available from each chain-link module.

Accordingly, each of the chain-link modules works together to permit the associated chain-link converter 20A+, 20A−, 20B+, 20B−, 20C+, 20C− to provide a stepped variable voltage source. This permits the generation of a voltage waveform across each chain-link converter 20A+, 20A−, 20B+, 20B−, 20C+, 20C− using a step-wise approximation. Operation of each chain-link converter 20A+, 20A−, 20B+, 20B−, 20C+, 20C− in this manner can be used to generate an AC voltage waveform at the corresponding AC terminal 18A, 18B, 18C.

In addition to the foregoing, the voltage source converter 10 includes a controller 22 that is arranged in operative communication with each chain-link converter 20A+, 20A−, 20B+, 20B−, 20C+, 20C−, and further is programmed to carry out the first method of embodiments of the invention.

More particularly the controller carries out a first step (a) of: obtaining a respective AC current demand phase waveform I_{A}, I_{B}, I_{C} for each converter limb 12A, 12B, 12C which each converter limb 12A, 12B, 12C is required to track; obtaining a DC current demand I_{DC} which the converter limbs 12A, 12B, 12C are also required to track; and obtaining a target stored energy value E_{0A+}, E_{0A-}, E_{0B+}, E_{0B-}, E_{0C+}, E_{0C-} that each corresponding chain-link converter 20A+, 20A−, 20B+, 20B−, 20C+, 20C− should aim to have stored therein under steady-state operating conditions.

The various AC current demand phase waveforms I_{A}, I_{B}, I_{C}, the DC current demand I_{DC} and the target stored energy values E_{0A+}, E_{0A-}, E_{0B+}, E_{0B-}, E_{0C+}, E_{0C-} may be obtained directly from a higher-level controller within the particular voltage source converter 10 or from some other external entity. Alternatively the particular voltage source converter may obtain them directly by carrying out its own calculations, e.g. using Active and Reactive power control loops.

The various AC current demand phase waveforms I_{A}, I_{B}, I_{C} and the DC current demand I_{DC} are expressed as a target current demand vector I_{ABC-DC}⁰(k) as follows:

$${I}_{ABC - DC}^{0} ( k ) = [ \begin{matrix}{I}_{ABC}^{0} ( k ) \\ {I}_{DC}^{0} ( k )\end{matrix} ]$$

where,

$${I}_{ABC}^{0} ( k ) = [ \begin{matrix}{I}_{A} ( k ) \\ {I}_{B} ( k ) \\ {I}_{C} ( k )\end{matrix} ]$$

with,

I_{A}(k), I_{B}(k), I_{C}(k) being the respective AC current demand phase waveforms I_{A}, I_{B}, I_{C} for each converter limb 12A, 12B, 12C at time instant k, and

I_{DC}(k) being the DC current demand I_{DC} at that same instant of time.

The respective target stored energy values E_{0A+}, E_{0A-}, E_{0B+}, E_{0B-}, E_{0C+}, E_{0C-} for each corresponding chain-link converter 20A+, 20A−, 20B+, 20B−, 20C+, 20C− are expressed as a target stored energy vector E₀ as follows:

E₀=[E_{0A}+E_{OA}−E_{0B}+E_{OB}−E_{0C}+E_{0C}−]^{T}

Each chain-link converter 20A+, 20A−, 20B+, 20B−, 20C+, 20C− stores energy via the capacitor included in each of the plurality of chain-link modules which make up the respective chain-link converter 20A+, 20A−, 20B+, 20B−, 20C+, 20C− and, as mentioned above, the target stored energy E_{0A+}, E_{0A-}, E_{0B+}, E_{0B-}, E_{0C+}, E_{0C-} is the target energy that each chain-link converter 20A+, 20A−, 20B+, 20B−, 20C+, 20C− should ideally have stored when operating under steady-state conditions.

As such each particular target stored energy E_{0A+}, E_{0A-}, E_{0B+}, E_{0B-}, E_{0C+}, E_{0C-} is, in an embodiment, obtained by way of

$${E}_{0} = \frac{{N}_{cmax}}{2} {CV}_{t}^{2}$$

where,

C is the capacitance of the capacitor in each chain-link module;

N_{cmax} is the total number of capacitors in each chain-link converter; and

Vₜ is a predefined target voltage of each individual capacitor in the respective chain-link modules when operating under steady-state conditions.

The target stored energy E_{0A+}, E_{0A-}, E_{0B+}, E_{0B-}, E_{0C+}, E_{0C-} for each chain-link converter 20A+, 20A−, 20B+, 20B−, 20C+, 20C− may differ from one another or, as is the case in the example embodiment described herein, may be the same as one another, i.e. each equal to the same target stored energy value E₀, such that the target stored energy vector E₀ is given by:

E₀=[E₀E₀E₀E₀E₀E₀]^{T}

The controller 22 also implements a second step (as indicated by a process box 102 in the flow diagram 100), i.e. step (b), of the first method of embodiments of the invention, by carrying out mathematical optimization to determine an optimal limb portion current I_{A+}, I_{A-}, I_{B+}, I_{B-}, I_{C+}, I_{C-} for each limb portion 12A+, 12A−, 12B+, 12B−, 12C+, 12C− that the limb portion 12A+, 12A−, 12B+, 12B−, 12C+, 12C− must contribute to track the corresponding required AC current demand phase waveform I_{A}, I_{B}, I_{C} and the required DC current demand Inc while minimising current conduction losses within each limb portion 12A+, 12A−, 12B+, 12B−, 12C+, 12C− and additionally managing the energy stored Ē_{A+}, Ē_{A-}, Ē_{B+}, Ē_{B-}, Ē_{C+} Ē_{C-} by each chain-link converter 20A+, 20A−, 20B+, 20B−, 20C+, 20C−.

More particularly, additionally managing the energy stored Ē_{A+}, Ē_{A-}, Ē_{B+}, Ē_{B-}, Ē_{C+}Ē_{C-} by each chain-link converter 20A+, 20A−, 20B+, 20B−, 20C+, 20C− includes both balancing the energy stored by each chain-link converter 20A+, 20A−, 20B+, 20B−, 20C+, 20C−, i.e. causing each chain-link converter 20A+, 20A−, 20B+, 20B−, 20C+, 20C− to store substantially the same amount of energy, and minimising the deviation in energy stored Ē_{A+}, Ē_{A-}, Ē_{B+}, Ē_{B-}, Ē_{C+} Ē_{C-} by each chain-link converter 20A+, 20A−, 20B+, 20B−, 20C+, 20C− from the target stored energy E_{0A+}, E_{0A-}, E_{0B+}, E_{0B-}, E_{0C+}, E_{0C-} it should have stored i.e., in the embodiment described, the identical target stored energy value E₀.

In addition to the foregoing, as will be described in more detail below, step (b) of carrying out mathematical optimization to determine the optimal limb portion current I_{A+}, I_{A-}, I_{B+}, I_{B-}, I_{C+}, I_{C-} for each limb portion 12A+, 12A−, 12B+, 12B−, 12C+, 12C− still further includes applying a first weighting α to the extent to which current conduction losses are minimised, a second different weighting β to the degree of stored energy balancing carried out, and a third further different weighting γ to the extent to which stored energy deviation is minimised. In other embodiments of the invention, two or more of the weightings α, β, γ may be identical to one another.

With particular reference to the type of mathematical optimization carried out, by way of example (with other types of mathematical optimization being possible), in the first method of embodiments of the invention a quadratic optimization problem is established of the general form

$${min}_{x} J = Ψ ( x ( {t}_{1} ) ) + {\int }_{{t}_{0}}^{{t}_{1}} f ( x ( t ) , t ) dt$$

where,

J is a current objective function to be minimized;

Ψ is a current weighting at time t₁;

f is a current cost function;

t₀ is the time at which a particular period of control of the voltage source converter 10 starts; and

t₁ is the time at which the particular period of control of the voltage source converter 10 ends.

The current objective function to be minimized is then defined as taking the form

J(I,Ē)

where,

I is an optimal limb portion currents vector composed of the individual limb portion currents I_{A+}, I_{A-}, I_{B+}, I_{C+}, I_{C-} that each corresponding limb portion 12A+, 12A−, 12B+, 12B−, 12C+, 12C− must contribute; and

Ē is an average chain-link converters stored energy vector composed of individual average energy amounts Ē_{A+}, Ē_{A-}, Ē_{B+}, Ē_{B-}, Ē_{C+} Ē_{C-} that each chain-link converter 20A+, 20A−, 20B+, 20B−, 20C+, 20C− is actually storing.

More particularly I takes the form of a column vector, i.e.

I(k)=[I_{A+}(k)I_{A}−(k)I_{B+}(k)I_{B-}(k)I_{C+}(k)I_{C-}(k)]^{T}

where,

I_{A}⁺(k) is the optimal limb portion current flowing through limb portion 12A+ at time instant k, with the same nomenclature applying to the rest of the optimal limb portion currents, i.e. I_{A-}, I_{B+}, I_{B-}, I_{C+}, I_{C-}. The sign convention for the limb portion currents I_{A+}, I_{A-}, I_{B+}, I_{B-}, I_{C+}, I_{C-} is shown in FIG. 2.

In this regard the limb portion currents I_{A+}, I_{A-}, I_{B+}, I_{B-}, I_{C+}, I_{C-} represent controllable variables in an overall control strategy, which means that they can be freely determined, i.e. optimal limb portion currents I_{A+}, I_{A-}, I_{B+}, I_{B-}, I_{C+}, I_{C-} determined, in order to fulfil the power demands and other current conduction and stored energy management constraints required to be fulfilled by the method of control.

Meanwhile the average chain-link converters stored energy vector Ē, at time instant k, is fully defined as:

Ē(k)=[Ē_{A+}(k)Ē_{A-}(k)Ē_{B+}(k)Ē_{B-}(k)Ē_{C+}(k)Ē_{C-}(k)]^{T}

Thereafter, the current objective function J(I, Ē) to be minimized is further defined by a linear combination of current conduction losses, stored energy deviations between the chain-link converters, and stored energy deviations from a target stored energy.

More particularly the current objective function is, in the embodiment shown (although other definitions are also possible), defined by

$$J ( I , \overline{E} ) = α {I}^{T} \cdot I + β {\sum }_{{{\overline{E}}_{i} , {\overline{E}}_{j}}_{i \neq j}} {( {\overline{E}}_{i} - {\overline{E}}_{j} )}^{2} + γ {\sum }_{{\overline{E}}_{i}} {( {\overline{E}}_{i} - {E}_{{0}_{i}} )}^{2}$$

where

(i) the current conduction losses are multiplied by the first weighting α and are given by

I^{T}·I

with I being the optimal limb portion currents vector described hereinabove;

(ii) the stored energy deviations between the chain-link converters are multiplied by the second weighting β and are given by

$${\sum }_{{{\overline{E}}_{i} , {\overline{E}}_{j}}_{i \neq j}} {( {\overline{E}}_{i} - {\overline{E}}_{j} )}^{2}$$

with,

Ēᵢ being the average energy in an i-th chain-link converter (where i=A+, A−, B+, B−, C+, C−); and

Ēⱼ being the average energy in a j-th chain-link converter (where j=A+, A−, B+, B−, C+, C−); and

(iii) the stored energy deviations from a target stored energy are multiplied by the third weighting γ and are given by

$${\sum }_{{\overline{E}}_{i}} {( {\overline{E}}_{i} - {E}_{{0}_{i}} )}^{2}$$

with,

Ēᵢ again being the average energy stored in an i-th chain-link converter; and

Ē₀_{ᵢ} being the target stored energy an i-th chain-link converter should have stored under steady-state operating conditions.

Following the aforementioned steps the current objective function, i.e.

$$J ( I , \overline{E} ) = α {I}^{T} \cdot I + β {\sum }_{{{\overline{E}}_{i} , {\overline{E}}_{j}}_{i \neq j}} {( {\overline{E}}_{i} - {\overline{E}}_{j} )}^{2} + γ {\sum }_{{\overline{E}}_{i}} {( {\overline{E}}_{i} - {E}_{{0}_{i}} )}^{2}$$

is minimised subject to:

(i) a first equality constraint expressed as a linear equation of the form

A₁·x=b₁;

(ii) an additional second equality constraint expressed as a linear equation of the form

A₂·x=b₂; and

(iii) an additional third equality constraint expressed as a linear equation of the form

A₃·x=b₃

In each of the foregoing instances the state vector, i.e. x, is given by

x(k)=[I(k)Ē(k)]^{T}

where, as set out above,

I is the optimal limb portion currents vector composed of individual limb portion currents that each corresponding limb portion must contribute; and

Ē is the average chain-link converters stored energy vector composed of individual average energy amounts that each chain-link converter is actually storing.

Meanwhile the first, second, and third equality constraints are concatenated into a compact linear system of the form

A·x=b

with,

A being defined as

$$A = [ \begin{matrix}{A}_{1} \\ {A}_{2} \\ {A}_{3}\end{matrix} ]$$

and b being defined as:

$$b = [ \begin{matrix}{b}_{1} \\ {b}_{2} \\ {b}_{3}\end{matrix} ]$$

Meanwhile, the first equality constraint A₁·x=b₁ firstly incorporates power demands based on the respective AC current demand phase waveforms I_{A}, I_{B}, I_{C}, for each converter limb 12A, 12B, 12C and the DC current demand I_{DC}.

More particularly,

A₁=[M₆M_{E}]

with the matrix A₁ incorporating the power demands by way of matrix M₆ that is defined as

$${M}_{6} = [ \begin{matrix}{α}_{A}^{+} & - {α}_{A}^{-} & 0 & 0 & 0 & 0 \\ 0 & 0 & {α}_{B}^{+} & - {α}_{B}^{-} & 0 & 0 \\ 0 & 0 & 0 & 0 & {α}_{C}^{+} & - {α}_{C}^{-} \\ {α}_{A}^{+} & 0 & {α}_{B}^{+} & 0 & {α}_{C}^{+} & 0\end{matrix} ]$$

and which is based on the following system of linear equations that include the AC current demand phase waveform I_{A}, I_{B}, I_{C}, for each converter limb 12A, 12B, 12C and the DC current demand I_{DC}:

$$\{ \begin{matrix}{I}_{A} = {α}_{A}^{+} {I}_{A +} - {α}_{A}^{-} {I}_{A -} \\ {I}_{B} = {α}_{B}^{+} {I}_{B +} - {α}_{B}^{-} {I}_{B -} \\ {I}_{C} = {α}_{C}^{+} {I}_{C +} - {α}_{C}^{-} {I}_{C -} \\ {I}_{DC} = {α}_{A}^{+} {I}_{A +} + {α}_{B}^{+} {I}_{B +} + {α}_{C}^{+} {I}_{C +}\end{matrix} \qquad ( 1 )$$

with the variables α_{A}⁺, α_{A}⁻, α_{B}⁺, α_{B}⁻, α_{C}⁺, α_{C}⁻ representing, respectively, the operating state of the corresponding chain-link converter 20A+, 20A−, 20B+, 20B−, 20C+, 20C− in each limb portion 12A+, 12A−, 12B+, 12B−, 12C+, 12C−, i.e. the binary variables at indicating whether the respective limb portion 12A+, 12A−, 12B+, 12B−, 12C+, 12C− is modulating normally a requested reference voltage (αᵢ^{±}=1) or is blocked (αᵢ^{±}=0).

In addition the first equality constraint A₁·x=b₁ secondly incorporates stored energy compensation factors by way of matrix M_{E} and vector b₁.

Matrix M_{E} is defined by

$${M}_{E} = [ \begin{matrix}{Kp}_{AC} + {T}_{i} {Ki}_{AC} \\ {Kp}_{DC} + {T}_{i} {Ki}_{DC}\end{matrix} ]$$

where,

constants Kp_{AC}, Ki_{AC}, Kp_{DC}, Ki_{DC} are energy correction gains with each of Kp_{AC} and Ki_{AC} being (3,6) matrices and each of Kp_{DC} and Ki_{DC} being (1,6) matrices; and

Tᵢ is a predefined integration time.

The foregoing matrix M_{E} is based on the following proportional-plus-integral feedback loops (although other control loops may be used) that relate stored energy deviations and corresponding energy correction currents to one another in the following manner:

I_{ABC}_{_{E}}(k)=Kp_{AC}·ΔE(k)+Integ_{ABC}_{_{E}}(k−1)+TᵢKi_{AC}·ΔE(k)

I_{DC}_{_{E}}(k)=Kp_{DC}·ΔE(k)+Integ_{DC}_{_{E}}(k−1)+TᵢKi_{DC}·ΔE(k)

where,

I_{ABC}_{_{E}}(k) establishes the AC correction currents needed to balance the energy stored in each chain-link converter 20A+, 20A−, 20B+, 20B−, 20C+, 20C− and minimise the deviation in stored energy from the target stored energy value; and

I_{DC}_{_{E}}(k) establishes the DC correction current needed to achieve the same aforementioned stored energy management result.

I_{ABC}_{_{E}}(k) and I_{DC}_{_{E}}(k) are derived by considering an energy balancing current vector I_{ABC-DC}_{_{E}}(k) which maps energy deviation ΔE(k) into correction currents, is defined as:

$${I}_{ABC - {DC}_{E}} ( k ) = [ \begin{matrix}{I}_{{ABC}_{E}} ( k ) \\ {I}_{{DC}_{E}} ( k )\end{matrix} ]$$

and follows from an understanding that a total current demand vector I_{ABC-DC}(k) is obtained as a combination of the target current demand vector I_{ABC-DC}⁰(k) (as defined hereinabove) and the aforementioned energy balancing current vector I_{ABC-DC}⁰(k), i.e:

I_{ABC-DC}(k)=I_{ABC-DC}⁰(k)+I_{ABC-DC}_{_{E}}(k)

Meanwhile,

ΔE(k) is an energy deviation vector that is obtained as the difference between the target stored energy vector E₀ and the average chain-links stored energy vector Ē(k), i.e.

ΔĒ(k)=E₀−Ē(k); and

Integ_{ABC}_{_{E}}(k−1) and Integ_{DC}_{_{E}}(k−1) are accumulated energy correction values that are used to achieve a smooth convergence of the stored energy Ē_{A+}, Ē_{A-}, Ē_{B+}, Ē_{B-}, Ē_{C+} E_{C-} of each chain-link converter 20A+, 20A−, 20B+, 20B−, 20C+, 20C− to its corresponding target stored energy E_{0A+}, E_{0A-}, E_{0B+}, E_{0B-}, E_{0C+}, E_{0C-}.

In the meantime, vector b₁ is defined by

$${b}_{1} = {I}_{ABC - DC}^{0} ( k ) + [ \begin{matrix}{Kp}_{AC} \cdot {E}_{0} + {Integ}_{{ABC}_{E}} ( k - 1 ) + {T}_{i} {Ki}_{AC} \cdot {E}_{0} \\ {Kp}_{DC} \cdot {E}_{0} + {Integ}_{{DC}_{E}} ( k - 1 ) + {T}_{i} {Ki}_{DC} \cdot {E}_{0}\end{matrix} ]$$

where,

I_{ABC-DC}⁰(k) is, as set out above given by

$${I}_{ABC - DC}^{0} ( k ) = [ \begin{matrix}{I}_{A} ( k ) \\ {I}_{B} ( k ) \\ {I}_{C} ( k ) \\ {I}_{DC} ( k )\end{matrix} ] ;$$

and

E₀ is the target stored energy vector as defined hereinabove.

The second equality constraint A₂·x=b₂ incorporates a consideration of changes in the average energy stored by each chain-link converter.

More particularly

A₂=[f(V_{caps}(k))Identity(6)]; and

$${b}_{2} = \overline{E} ( k - 1 ) + {{\sum }_{j = 0}}^{N - 1} g ( {V}_{caps} ( k - j ) )$$

where,

f (V_{caps}(k)) and g(V_{caps}(k−j)) are linear vector functions that take as arguments the voltage V_{caps} of each capacitor in the various chain-link converters 20A+, 20A−, 20B+, 20B−, 20C+, 20C− at time instant k; and

Identity(6) is a square matrix of dimension 6×6, composed of 1's in the main left-to-right diagonal and 0's everywhere else.

The third equality constraint A₃·x=b₃ incorporates a requirement that the AC current demand phase waveform for each converter limb sums to zero at the corresponding AC terminal, i.e. the third equality constraint incorporates the following requirement:

I_{A}+I_{B}+I_{C}=(I_{A}⁺−I_{A}⁻)+(I_{B}⁺−I_{B}⁻)+(I_{C}⁺−I_{C}⁻)=0

which can be written in the aforementioned matrix form, i.e. as A₃·x=b₃,

with

A₃=[1(−1)1(−1)1(−1)000000]

and

b₃=0

In use the controller 22 determines, using the above-described mathematical optimization, an optimal limb portion current I_{A+}, I_{A-}, I_{B+}, I_{C+}, I_{C-} for each limb portion 12A+, 12A−, 12B+, 12B−, 12C+, 12C− that the limb portion 12A+, 12A−, 12B+, 12B−, 12C+, 12C− must contribute so as to: minimise current conduction losses within each limb portion 12A+, 12A−, 12B+, 12B−, 12C+, 12C−; additionally balance the energy stored Ē_{A+}, Ē_{A-}, Ē_{B+}, Ē_{B-}, Ē_{C+} Ē_{C-} by each chain-link converter 20A+, 20A−, 20B+, 20B−, 20C+, 20C−, i.e. cause each chain-link converter 20A+, 20A−, 20B+, 20B−, 20C+, 20C− to store substantially the same amount of energy E₀; and minimise the deviation in energy stored Ē_{A+}, Ē_{A-}, Ē_{B+}, Ē_{B-}, Ē_{C+} Ē_{C-} by each chain- link converter 20A+, 20A−, 20B+, 20B−, 20C+, 20C− from the target stored energy E_{0A+}, E_{0A-}, E_{0B+}, E_{0B-}, E_{0C+}, E_{0C-} it should have stored i.e., in the embodiment described, the identical target stored energy value E₀.

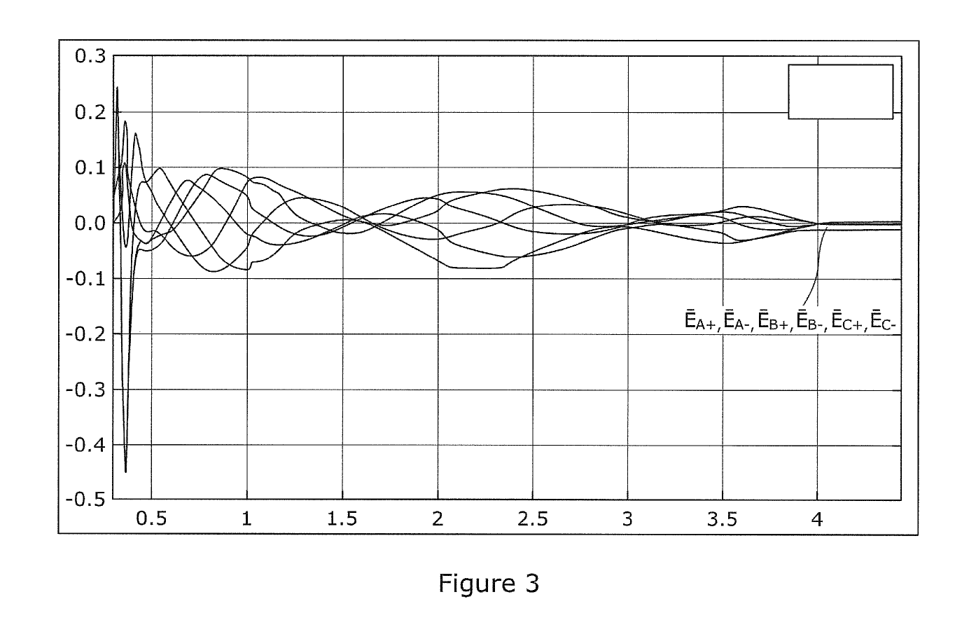

As a consequence of the latter two outcomes the energy stored Ē_{A+}, Ē_{A-}, Ē_{B+}, Ē_{B-}, Ē_{C+} Ē_{C-} by each chain-link converter 20A+, 20A−, 20B+, 20B−, 20C+, 20C− converges on a desired target stored energy value E₀, e.g. zero joules (J), as shown in FIG. 3.

Meanwhile the controller 22 achieves the foregoing while continuing to track the required AC current demand phase waveforms I_{A}, I_{B}, I_{C} and the required DC current demand I_{DC}.

This written description uses examples to disclose the invention, including the preferred embodiments, and also to enable any person skilled in the art to practice the invention, including making and using any devices or systems and performing any incorporated methods.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of controlling a voltage source converter including at least one converter limb corresponding to a respective phase of the converter, the or each converter limb extending between first and second DC terminals and including first and second limb portions separated by an AC terminal, each limb portion includes a chain-link converter operable to provide a stepped variable voltage source, the method comprising the steps of:
(a) obtaining a respective AC current demand phase waveform for the or each converter limb which the corresponding converter limb is configured to track, and a DC current demand which the or each converter limb is also required to track; and
(b) carrying out mathematical optimization to determine an optimal limb portion current for each limb portion that the limb portion must contribute to track the corresponding required AC current demand phase waveform and the required DC current demand while minimising current conduction losses within each limb portion and additionally managing the energy stored by each chain-link converter.

2. The method according to claim 1 wherein managing the energy stored by each chain-link converter includes balancing the energy stored by each chain-link converter.

3. The method according to claim 1 further comprising within step (a) obtaining a target stored energy that each chain-link converter should aim to have stored therein under steady-state operating conditions, and wherein managing the energy stored by each chain-link converter includes minimising the deviation in energy stored by each chain-link converter from the target stored energy it should have stored.

4. The method according to claim 1 wherein step (b) of carrying out mathematical optimization to determine an optimal limb portion current for each limb portion includes applying a first weighting to the extent to which current conduction losses are minimised and a second different weighting to the degree of stored energy management carried out.

5. The method according to claim 4 wherein step (b) of carrying out mathematical optimization to determine an optimal limb portion current for each limb portion includes applying a second different weighting to the degree of stored energy balancing carried out and a third further different weighting to the extent to which stored energy deviation is minimised.

6. The method according to claim 1 wherein step (b) of carrying out mathematical optimization to determine an optimal limb portion current for each limb portion includes establishing a quadratic optimization problem of the general form
$${mix}_{x} J = Ψ ( x ( {t}_{1} ) ) + {\int }_{{t}_{0}}^{{t}_{1}} f ( x ( t ) , t ) dt$$
where,
J is a current objective function to be minimized;
Ψ is a current weighting at time t₁;
f is a current cost function;
t₀ is the time at which a particular period of control of a particular voltage source converter starts; and
t₁ is the time at which the particular period of control of a particular voltage source converter ends.

7. The method according to claim 6 wherein the current objective function to be minimized takes the form
J(I,Ē)
where,
I is an optimal limb portion currents vector composed of individual limb portion currents that each corresponding limb portion must contribute; and
Ē is an average chain-link converters stored energy vector composed of individual average energy amounts that each chain-link converter is actually storing.

8. The method according to claim 7 wherein the current objective function to be minimized is defined by a linear combination of current conduction losses, stored energy deviations between the chain-link converters, and stored energy deviations from a target stored energy.

9. The method according to claim 8 wherein the current conduction losses are given by
I^{T}·I
where,
I is an optimal limb portion currents vector composed of individual limb portion currents that each corresponding limb portion must contribute.

10. The method according to claim 8 wherein the stored energy deviations between the chain-link converters are given by
$${\sum }_{{{\overline{E}}_{i} , {\overline{E}}_{j}}_{i \neq j}} {( {\overline{E}}_{i} - {\overline{E}}_{j} )}^{2}$$
where,
Ēᵢ is the average energy stored in an i-th chain-link converter; and
Ēⱼ is the average energy stored in a j-th chain-link converter.

11. The method according to claim 8 wherein the stored energy deviations from a target stored energy are given by
$${\sum }_{{\overline{E}}_{i}} {( {\overline{E}}_{i} - {E}_{{0}_{i}} )}^{2}$$
where,
Ēᵢ is the average energy stored in an i-th chain-link converter; and
E₀_{ᵢ} is the target stored energy an i-th chain-link converter should have stored under steady-state operating conditions.

12. The method according to claim 7 wherein the current objective function is minimised subject to a first equality constraint expressed as a linear equation of the form
A₁·x=b₁
and firstly incorporating power demands based on the respective AC current demand phase waveform for the or each converter limb and the DC current demand, as well as secondly incorporating stored energy compensation factors.

13. The method according to claim 12 wherein the current objective function is minimised subject to an additional second equality constraint expressed as a linear equation of the form
A₂·x=b₂
and incorporating a consideration of changes in the average energy stored by each chain-link converter.

14. The method according to claim 12 of controlling a voltage source converter including a plurality of converter limbs, wherein the current objective function is minimised subject to an additional third equality constraint expressed as a linear equation of the form
A₃·x=b₃
and incorporating a requirement that the AC current demand phase waveform for each converter limb sums to zero at the corresponding AC terminal.

15. The method according to claim 14 wherein the first, second, and third equality constraints are concatenated into a compact linear system of the form
A·x=b
where,
A is defined as
$$A = [ \begin{matrix}{A}_{1} \\ {A}_{2} \\ {A}_{3}\end{matrix} ]$$
and b is defined as:
$$b = [ \begin{matrix}{b}_{1} \\ {b}_{2} \\ {b}_{3}\end{matrix} ]$$

16. The method according to claim 12 wherein the state vector is given by
x(k)=[I(k)Ē(k)]^{T}
where,
I is an optimal limb portion currents vector composed of individual limb portion currents that each corresponding limb portion must contribute; and
Ē is an average chain-link converters stored energy vector composed of individual average energy amounts that each chain-link converter is actually storing.

17. A voltage source converter comprising at least one converter limb corresponding to a respective phase of the converter, the or each converter limb extending between first and second DC terminals and including first and second limb portions separated by an AC terminal, each of which limb portion includes a chain-link converter operable to provide a stepped variable voltage source, the voltage source converter further comprising a controller programmed to:
(a) obtain a respective AC current demand phase waveform for the or each converter limb which the corresponding converter limb is required to track, and a DC current demand which the or each converter limb is also required to track; and
(b) carry out mathematical optimization to determine an optimal limb portion current for each limb portion that the limb portion must contribute to track the corresponding required AC current demand phase waveform and the required DC current demand while minimising current conduction losses within each limb portion and additionally managing the energy stored by each chain-link converter.
